(19) United States
(12) Patent Application Publication
(10) Pub. No.: US 2004/0027029 A1
(43) Pub. Date: Feb. 12, 2004

(54) Lorentz force microelectromechanical system (MEMS) and a method for operating such a MEMS

(75) Inventors: Robert L. Borwick III, Thousand Oaks, CA (US); Jeffrey F. DeNatale, Thousand Oaks, CA (US)

Correspondence Address: Louis A. Mok, KOPPEL & JACOBS, Suite 107, 555 St. Charles Drive, Thousand Oaks, CA, 91360, US

(73) Assignee: Innovative Techology Licensing, LLC

(21) Appl. No.: 10/213,951

(22) Filed: Aug. 7, 2002

(51) Int. Cl. H02N 1/00

(52) U.S. Cl. 310/309

(57) ABSTRACT

A microelectromechanical system (MEMS), formed on a substrate, comprises a utilization device having a first state and a second state, and a Lorentz force actuator having an actuator element coupled to the utilization device. The actuator element is displaceable by the Lorentz force to alter the state of the utilization device from the first state to the second state thereof. An electrostatic device, coupled to the utilization device, is electrically chargeable to electrostatically hold the utilization device in the second state thereof with minimal electrical power consumption. The utilization device may be of any kind including electrical, fluidic, optical or mechanical. For example, the utilization device may comprise an electrical switch, in which case the first state of the utilization device may comprise an open state of the switch and the second state may comprise a closed state of the switch. The bidirectionality of the Lorentz force facilitates opening a MEMS switch whose contacts are stuck and makes possible the design of MEMS switches having double-throw configurations.

Also disclosed is a method for operating a MEMS actuator having an electrically conductive actuator element movable between a first position and a second position. The method comprises the steps of passing an electrical current through the actuator element in a predetermined direction in the presence of an intercepting magnetic field to move the actuator element from the first position toward the second position in response to the action of the Lorentz force, electrostatically holding the actuator element in the second position, and terminating the electrical current through the actuator element.

### BACKGROUND OF THE INVENTION

1. Field of the Invention

The present invention relates generally to microelectromechanical systems and particularly to a MEMS incorporating an actuator whose operation uses the Lorentz force. The invention further relates to a method for operating such a MEMS.

2. Description of the Related Art

MEMS comprise a class of very small electromechanical devices that combine many of the most desirable aspects of conventional mechanical and solid-state devices. Unlike conventional electromechanical devices, MEMS can be monolithically integrated with integrated circuitry while providing both low insertion losses and high electrical isolation.

The two main categories of MEMS are actuators and sensors. MEMS actuators can be very precise because they perform only a small amount of work on their environment. MEMS sensors are virtually non-invasive because of their small physical size.

Various methods are used to operate MEMS actuators; for example, they may be activated electrostatically, electromagnetically or thermally. Each has its disadvantages. For example, electrostatic actuators not only require high voltages to create sufficient attractive forces to deflect a movable armature element such as a beam or a cantilevered arm, but are difficult to implement in bidirectional configurations in the absence of a separate repulsive driving force. Further, electrostatic MEMS actuators in the form of electrical switches are prone to contact sticking and the development of electrostatically activated double-throw MEMS switches has been impeded by the limitations on bidirectional operation. Electromagnetically activated MEMS actuators, although operable on relatively low voltages, tend to be bulky and require special permalloy materials. Thermal MEMS switches are extremely slow, incorporate high power consumption heater elements whose energization may also interfere with RF pathways, and, like electrostatic actuators, are difficult to implement so as to operate bidirectionally.

There exist MEMS sensors using the Lorentz force for deflecting a member such as a plate or beam in response to a variable such as an electrical current or magnetic field whose magnitude is to be measured. See, for example, U.S. Pat. No. 6,188,322 to Yao, et al., and H. Emmerich, et al., “A Novel Micromachined Magnetic-Field Sensor”, Technical Digest, IEEE International MEMS 1999 Conference, pages 94-99.

As is well known, the Lorentz force is produced when a charged particle q moves with a velocity v in a region where there is both an electric field E and a magnetic field B. The total force F (the Lorentz force) on the charged particle is the vector sum of the electric force qE and the magnetic force qvxB. In the absence of an electric field, the force on the charged particle, in scalar form, reduces to:

F=qvB sin θ

where θ is the angle between v and B and the force F is perpendicular to both v and B.

Thus, a movement or displacement of an electrical conductor may be effected by the interaction between a defined electrical current through the conductor and an external magnetic field. The direction of the current through the conductor and the direction of the external magnetic field determine the direction of the Lorentz force. Devices relying upon the Lorentz force for operation, however, tend to consume substantial amounts of electrical power.

It is an overall object of the present invention to provide a MEMS incorporating an actuator that utilizes the Lorentz force but whose electrical power consumption is minimized.

It is another overall object of the present invention to provide a MEMS switch incorporating an actuator that uses the Lorentz force for its operation.

### SUMMARY OF THE INVENTION

In accordance with one specific, exemplary embodiment of the invention, there is provided a microelectromechanical system (MEMS) formed on a substrate, the MEMS comprising a utilization device having a first state and a second state; a Lorentz force actuator comprising an actuator element coupled to the utilization device, the actuator element being displaceable by the Lorentz force to alter the state of the utilization device from the first state to the second state thereof; and an electrostatic device coupled to the utilization device, the electrostatic device being electrically chargeable to electrostatically hold the utilization device in the second state thereof. The utilization device may thus be held in its second state with minimal electrical power consumption.

The utilization device may comprise a device selected from the group consisting of an electrical utilization device, a fluidic utilization device, an optical utilization device and a mechanical utilization device. For example, the utilization device may comprise an electrical switch, in which case the first state of the utilization device may comprise an open state of the switch and the second state may comprise a closed state of the switch. In accordance with a specific form of such an electrical switch, the switch includes a fixed switch contact carried by the MEMS substrate and a movable switch contact mounted adjacent the free end of a cantilever having a fixed end secured to the substrate, the actuator element being coupled to the cantilever.

Pursuant to another aspect of the invention, there is provided an apparatus comprising a MEMS module including an armature deflectable between a first state and a second state; a utilization device responsive to the deflection of the armature and movable thereby from a first position corresponding to the first state of the armature, to a second position corresponding to the second state of the armature; and an electrostatic device coupled to the utilization device. The apparatus further comprises a first voltage source connectable to the armature for passing an electrical current through the armature; a second voltage source connectable to the electrostatic device; and means for producing a magnetic field oriented to intercept the electrical current passing through the armature. The passage of current through the armature causes the armature to deflect from the first state to the second state thereof in response to the action of the Lorentz force, the electrostatic device being electrically chargeable by the second voltage source to electrostatically hold the utilization device in the second position thereof.

In accordance with another, specific, exemplary embodiment of the invention, there is provided a MEMS electrical switch formed on a substrate, the MEMS switch comprising an electrically conductive actuator element attached to an electrically conductive anchor structure formed on the substrate. At least a portion of the actuator element is movable relative to the substrate between a rest state and a forced state, the actuator element being adapted to be connected to an electrical power supply through the anchor structure for passing an electrical current through the actuator element. The movable portion of the actuator element carries an electrical contact means. The MEMS switch further comprises a load circuit terminal means formed on the substrate, the electrical contact means carried by the movable portion of the actuator element confronting the load circuit terminal means and being separated therefrom by a gap in the rest state of the movable portion of the actuator element. In operation, passing an electrical current through the actuator element in the presence of a magnetic field intercepting the electrical current causes the movable portion of the actuator element to move from the rest state to the forced state in response to the action of the Lorentz force to close the gap between the electrical contact means and the load circuit terminal means to thereby close the MEMS switch.

Further, the movable portion of the actuator element may be coupled to an electrostatic drive chargeable to electrostatically hold the movable portion of the actuator element in the forced state.

The bidirectionality of the Lorentz force facilitates opening a MEMS switch whose contacts are stuck. In addition, this bidirectionality makes possible the design of MEMS switches having double-throw configurations. Thus, in accordance with yet another feature of the invention, the load circuit terminal means of the MEMS switch may comprise (i) a first load circuit terminal means comprising a first pair of spaced apart terminals and (ii) a second load circuit terminal means comprising a second pair of spaced apart terminal means. The movable portion of the actuator element is movable between the rest state and a first forced state in response to an electrical current passing through the actuator element in one direction and between the rest state and a second forced state in response to an electrical current passing through the actuator element in an opposite direction. The electrical contact means comprises (i) a first electrically conductive bridge having spaced apart contact surfaces disposed to engage the first pair of spaced apart terminals in the first forced state of the movable portion of the actuator element, and (ii) a second electrically conductive bridge having spaced apart contact surfaces disposed to engage the second pair of spaced apart terminals in the second forced state of the movable portion of the actuator element.

Pursuant to yet another aspect of the invention, there is provided a method for operating a MEMS actuator comprising an electrically conductive actuator element movable between a first position and a second position. The method comprises the steps of passing an electrical current through the actuator element in a predetermined direction in the presence of an intercepting magnetic field to move the actuator element from the first position toward the second position in response to the action of the Lorentz force; electrostatically holding the actuator element in the second position; and terminating the electrical current through the actuator element. The method may further comprise the-step of passing an electrical current through the actuator element in a direction opposite the predetermined direction to move the actuator element from the second position toward the first position in response to the action of the Lorentz force. Still further, the method of the invention may additonally comprise the steps of terminating the electrostatic hold of the actuator element; and passing an electrical current through the actuator element in a direction opposite said predetermined direction to move the actuator element from the second position toward the first position in response to the action of the Lorentz force. The actuator element may be made to be movable between the first position and a third position opposite the second position, in which case the method further comprises the step of passing an electrical current through the actuator element in a direction opposite the predetermined direction to move the actuator element from the first position toward the third position in response to the action of the Lorentz force.

### BRIEF DESCRIPTION OF THE DRAWINGS

The foregoing and other objects, features and advantages of the invention will be apparent to those skilled in the art from the following detailed description of the preferred embodiments when taken together with the accompanying drawings, in which:

FIG. 1 is a top plan view of a MEMS in accordance with a first, specific, exemplary embodiment of the present invention comprising a laterally displaceable, Lorentz force actuator for operating a single-pole, single-throw (SPST) electrical switch;

FIG. 2 is a top plan view of a MEMS in accordance with a second, specific, exemplary embodiment of the present invention comprising a laterally displaceable, Lorentz force actuator for operating a double-throw electrical switch;

FIG. 3A shows cross-hatchings identifying the various materials used for the layers shown in the sectional views of FIGS. 3B-3F;

FIGS. 3B-3F are sectional views, as seen along the line 3-3 in FIG. 2, showing steps in the fabrication of a portion of the MEMS actuator of FIG. 2;

FIG. 4 is a top plan view of a MEMS actuator in accordance with a third, specific, exemplary embodiment of the present invention comprising another laterally displaceable, Lorentz force actuator for operating a double-throw electrical switch;

FIG. 5 is a top plan view of a MEMS in accordance with a fourth, specific, exemplary embodiment of the present invention comprising a vertically displaceable Lorentz force actuator for operating a single-pole, single-throw (SPST) electrical switch;

FIG. 6 is a side elevation, sectional view of the MEMS of FIG. 5 as seen along the line 6-6 in FIG. 5;

FIG. 7 is an end elevation, sectional view, of the MEMS of FIG. 5 as seen along the line 7-7 in FIG. 5; and

FIG. 8 is a side elevation, sectional view of a MEMS in accordance with a fifth, specific, exemplary embodiment of the invention for operating a single-pole, single-throw electrical switch including a cantilever-mounted, movable contact.

### DETAILED DESCRIPTION OF THE INVENTION

The following description presents preferred embodiments of the invention representing the best mode contemplated for practicing the invention. This description is not to be taken in a limiting sense but is made merely for the purpose of describing the general principles of the invention whose scope is defined by the appended claims.

Although the invention will be described principally in connection with the actuation of MEMS electrical switches, it will be evident to those skilled in the art that the invention has applications not only in other electrical fields but also in the optical, fluidic and mechanical arts. For example, the invention may be used to actuate tuning capacitors as well as fluidic control elements, hinges and micro-mirror assemblies. In the context of electrical switches, the MEMS of the invention is particularly useful in radio frequency telecommunications systems, for example, for such tasks as band-select switching in cellular phones, antenna switching and transmit-receive switching. As is well known, among other advantages, a MEMS switch is capable of handling GHz signal frequencies while maintaining minimal insertion loss in the “on” or closed state and excellent electrical isolation in the “off” or open state, and thus tends to approach an ideal switch.

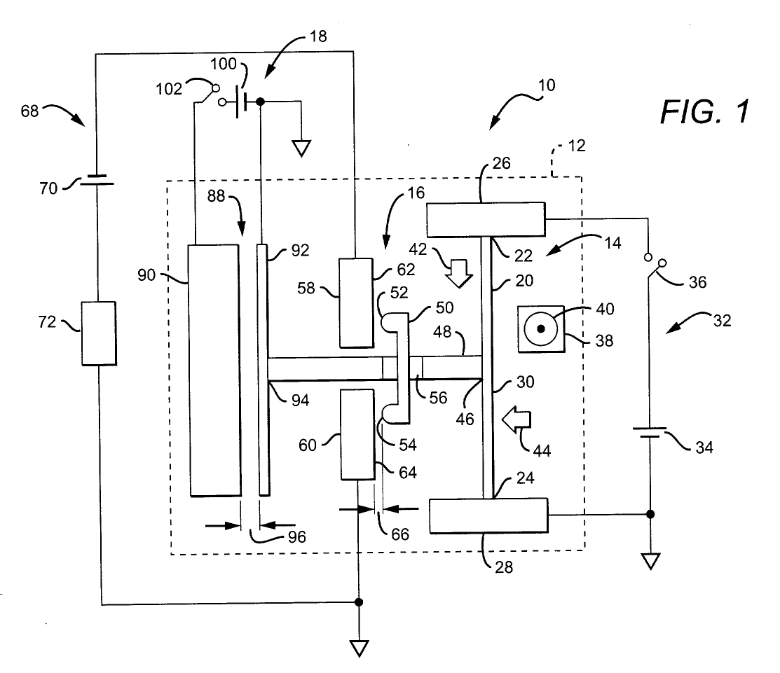

FIG. 1 shows an apparatus including a MEMS 10 in accordance with a first specific, exemplary embodiment of the invention. The MEMS 10 is formed on a substrate 12 using generally known microfabrication techniques such as bulk micromachining or surface micromachining. Basically, the MEMS 10 comprises a Lorentz force actuator 14, a utilization device 16 operated by the actuator 14 and an electrostatic hold device 18. In this example, the utilization device 16 comprises a normally open, single-pole, single-throw (SPST) switch having a first position or state (“off” or open) and a second position or state (“on” or closed).

The Lorentz force actuator 14 comprises an electrically conductive armature or actuator element 20 comprising a flexible suspension in the form of a beam suspended over the substrate 12 and having opposite, fixed ends 22 and 24 secured to electrically conductive anchors 26 and 28, respectively, formed on the substrate 12. The suspension 20 may be in the form of a compliant structure known in the art as a “silicon spring”. A central portion 30 of the flexible suspension 20 between the anchors 26 and 28 is displaceable laterally, that is, in a direction parallel with the substrate 12, between a rest (or undeflected) state (shown in FIG. 1) and a forced (or deflected) state. An actuator control circuit 32 comprising the series combination of an electrical power supply in the form of voltage source 34 of preferably reversible polarity, and a switch 36 is connected across the anchors 26 and 28. A means 38, such as a permanent magnet or electromagnet disposed above or below the substrate 12, provides a magnetic field represented by a magnetic vector symbol 40 extending in a direction up from the plane of FIG. 1. The voltage source 34 and the magnetic means 38 will typically be located off the substrate 12.

The Lorentz force actuator 14 operates as follows: When the switch 36 of the control circuit 32 is closed, current will flow through the suspension 20 in the direction indicated by an arrow 42. In response to the action of the Lorentz force (represented by an arrow 44) caused by the interaction of the electrical current 42 and the magnetic field 40, the central portion 30 of the suspension 20 is deflected laterally from its rest state to a forced state, displacing that portion to the left as seen in FIG. 1. Opening of the switch 36 terminates current flow through the suspension 20 and the central portion 30, given its elasticity, thereupon returns to its undeflected or rest state. It will be apparent that by reversing the polarity of the voltage source 34, current may be made to flow in a direction opposite to that of the arrow 42 causing deflection of central portion 30 of the suspension to the right as viewed in FIG. 1. Alternatively, the same result may be achieved by reversing the direction of the magnetic field 40. It will be appreciated that the greater the compliance of the suspension 20, the less electrical current, or magnetic field strength, or both, will be required to obtain a given displacement of the actuator,

Attached to the suspension 20, preferably at a point centered between the anchors 26 and 28, is one end 46 of a cantilevered arm 48 suspended over, and extending parallel with, the substrate 12. The arm 48 is oriented perpendicular to the suspension 20 and is laterally displaceable with the central portion 30 thereof to operate the utilization device or switch 16. The switch 16 includes an electrically conductive contact means in the form of a bridge 50 mounted on the movable arm 48 and disposed transverse thereto. The bridge 50 includes a pair of spaced apart contacts 52 and 54. The bridge 50 is secured to the arm 48 by means of a dielectric insert 56 electrically isolating the bridge from the arm 48 and the suspension 20.

The switch 16 further comprises terminal means in the form of a pair of spaced apart terminals 58 and 60 having surfaces 62 and 64, respectively, spaced and positioned so as to be engageable by the contacts 52 and 54 of the bridge 50. A gap 66 of about 1-5 microns, for example, is provided between the contacts 52 and 54, on the one hand, and the terminal surfaces 62 and 64, on the other, when the switch 16 is in its normally open state. With the contacts 52 and 54 bridging the terminals 58 and 60, a circuit 68 including, for example, the series combination of a power supply 70 and a load 72 across the terminals 58 and 60, is closed. In the absence of contact sticking, termination of the electrical current 42 through the suspension 20 causes the portion 30 of the suspension 20 to return to its rest or undeflected state.

In the preferred embodiment of FIG. 1, the Lorentz force actuator 14 and utilization device 16 are combined with the electrostatic drive or device 18 for providing the MEMS with a low power consumption hold or latching feature. In the example of FIG. 1, the electrostatic device 18 comprises a parallel plate capacitor 88 including a fixed electrode or plate 90 formed on the substrate 12 and a movable electrode or plate 92 secured to a free end 94 of the cantilevered arm 48. The movable plate 92 is parallel with the fixed plate 90 and is normally separated therefrom by a gap 96 of, for example, about 1.5 microns to about 5.5 microns, that is, at least about 0.5 micron larger than the gap 66. The gap 96 defines the holding range of the parallel plate electrostatic device 18; the holding range encompasses a “snap-down” range comprising approximately the final 2/3 of travel of the movable plate 92 toward the fixed plate 90. The series combination of a voltage source 100 and a hold switch 102 is connected across the capacitor 88. It will be apparent that alternatively, the electrostatic device 18 may be in the form of a comb capacitor, with the fixed plates of the comb capacitor formed on the substrate 12 and the interleaved or interdigitated movable comb capacitor plates attached to the cantilevered arm 48; as before, the gap separating adjacent movable and fixed plates should be larger than the gap 66 to avoid shorting the comb capacitor.

In accordance with one operating sequence, closing of the switch 16 is effected by passing current through the suspension 20 in a direction to deflect the suspension portion 30 so that the contact surfaces 52 and 54 engage the terminals 58 and 60 to close the switch 16. With voltage applied to the electrostatic device 18 through the switch 102, electrostatic forces attract the movable capacitor plate 92 toward the fixed plate 90. Because the initial gap 96 is larger than the initial gap 66, a small gap, for example, about 0.5 micron, within the snap-down range of the capacitor 88, remains between the capacitor plates 90 and 92 when the switch 16 is closed. Thus, the engagement of the contact surfaces 52 and 54 against the surfaces 62 and 64 of the terminals 58 and 60 provides a mechanical stop preventing the movable plate 92 from contacting the fixed plate 90 and short-circuiting the capacitor 88. The movable plate 92 nevertheless can be brought very close to the fixed plate 90 thereby creating a large electrostatic force between these plates and concomitantly a high pressure, low electrical resistance contact between the bridge 50 and the terminals 58 and 60. Switch 36 is then opened to terminate current flow through the suspension 20 and thereby to terminate the Lorentz force. Because the switch 16 is held closed electrostatically, the switch 16 requires almost no electrical power to stay in the closed state. Opening of the switch 16 is effected by terminating the energization of the electrostatic device 18. If necessary, to assist contact break and return the switch 16 to the off state, a short duration current pulse may be passed through the suspension 20 in a direction opposite to that of the actuating current 42. The problem of contact sticking is thereby overcome. Alternatively, where the magnetic field source is an electromagnet, the direction of the Lorentz force may be reversed by reversing the direction of the magnetic field instead of the armature current.

In accordance with another operating sequence, the electrostatic device 18 may be continuously energized by eliminating the switch 102. In this case, opening of the load switch 16 is effected by passing a short duration current pulse through the suspension 20 in a direction opposite that of the switch-closing current. With the plate 92 moved away from the fixed plate 90 by a distance exceeding the snap-down range, the switch 16 remains open.

As noted, because the Lorentz force may be easily made to act bidirectionally by virtue of the reversibility of the direction of the current through the suspension or the direction of the external magnetic field, there is provided a mechanism for producing both a closing force and an opening force. Further, the integrated electrostatic device 18 eliminates the need to energize the Lorentz force actuator 14 while the switch 16 is in the closed state and thereby, as already mentioned, minimizes power consumption.

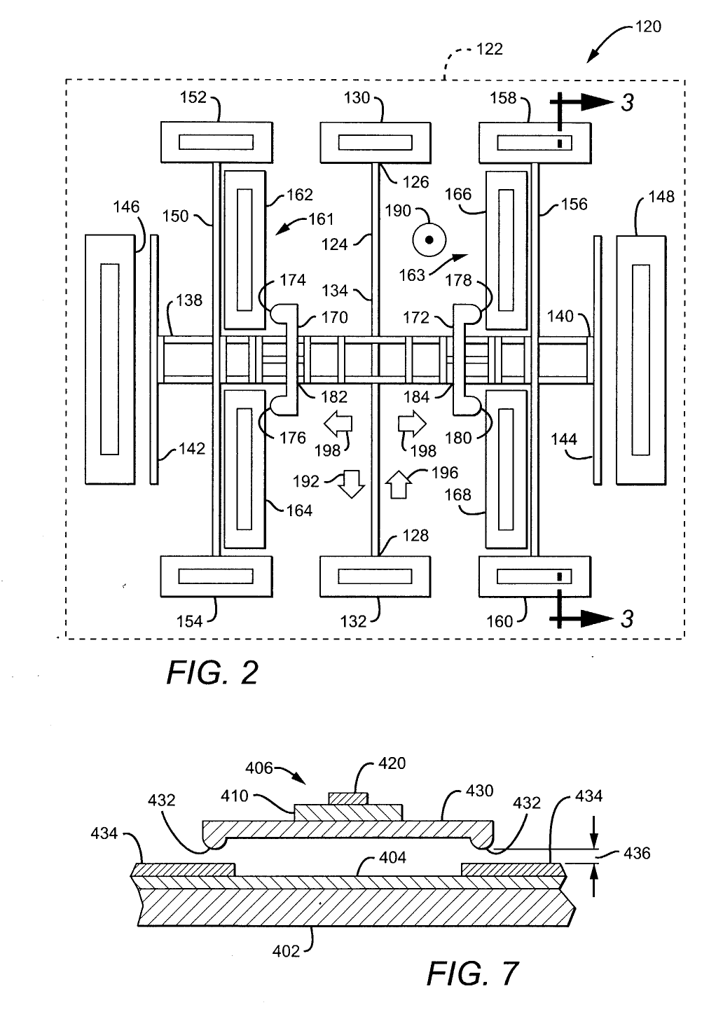

The bidirectionality of the present invention may be used to toggle a Lorentz force actuator between two forced states thereby making possible the implementation of a MEMS double-throw switch. In this connection, FIG. 2 shows a second specific, exemplary embodiment of the invention comprising a MEMS 120 including a utilization device in the form of a double-throw switch. The MEMS 120 is formed on a substrate 122. An electrically conductive Lorentz force actuator armature or suspension 124 in the form of a suspended beam fixed at both ends is mounted on the substrate 122. Specifically, the suspension 124 includes fixed ends 126 and 128 secured to electrically conductive anchors 130 and 132, respectively, mounted on the substrate 122. The suspension further comprises a central, deflectable, elastic portion 134 between the ends 126 and 128.

A suspended arm 136 is mechanically coupled to the central portion 134 of the suspension 124 and projects from both sides of the suspension, preferably perpendicular thereto. The arm 136 has opposite end portions terminating at extremities 138 and 140 carrying movable parallel plate capacitor plates 142 and 144, respectively, suspended above the substrate 122. Opposite the movable capacitor plates 142 and 144 and disposed parallel thereto are fixed capacitor plates 146 and 148, respectively, formed on the substrate 122. Although not shown in FIG. 2, an actuator control circuit similar to the circuit 32 in FIG. 1 may be provided for energizing the suspension 124. On the left side (as seen in FIG. 2), between the movable capacitor plate 142 and the suspension 124 is a left arm-supporting suspension or beam 150 attached to the arm 136 and suspended above the substrate between anchors 152 and 154 attached to the substrate 122. Similarly on the right side, a right arm-supporting suspension or beam 156 is disposed between the movable capacitor plate 144 and the suspension 124. The right suspension is attached to the arm 136 and is suspended between anchors 158 and 160 secured to the substrate.

The utilization device of the MEMS of FIG. 2 includes two switches 161 and 163 including fixed terminal means formed on the substrate 122. More specifically, the first switch 161 includes a pair of spaced apart, fixed terminals 162 and 164; the second switch 163 comprises a pair of spaced apart, fixed terminals 166 and 168. An external load circuit, similar to the circuit 68 in FIG. 1, may be connected across the fixed terminals of each of the switches.

The switches 161 and 163 include first and second contact bridges 170 and 172, respectively, mechanically coupled to the arm 136. The contact bridge 170 includes spaced apart contacts 174 and 176 positioned to engage the terminals 162 and 164; similarly, the contact bridge 172 includes contacts 178 and 180 positioned to engage the terminals 166 and 168. The contact bridges 170 and 172 are attached to the arm by means of electrically isolating, dielectric inserts 182 and 184, respectively.

A magnetic field, represented schematically by a vector 190, extends upwardly from the plane of the drawing. The source of the magnetic field may be a permanent magnet or an electromagnet (not shown) disposed above or below the substrate 122. A voltage source (not shown but similar to the source 34 in FIG. 1) of reversible polarity directs current through the suspension 124 in the direction shown by current vector 192. By cross-product of the current vector 192 with the magnetic vector 190, a Lorentz force is produced as represented by the force vector 194.

The Lorentz force induces deflection of the central portion of the suspension 124 towards the left as seen in FIG. 2. As a result, the arm 136 is also translated leftward, thereby bringing the contacts 174 and 176 on the bridge 170 into electrical contact with the terminals 162 and 164, respectively, and closing switch 161. Similarly, the movable capacitor plate 142 is moved towards the fixed plate 146. As before, the switch 161 is held closed after terminating current flow through the suspension by continuing energization of the electrostatic drive. Upon de-energization of the electrostatic drive, the suspension portion 134 and suspension beams 150 and 156 return to their unflexed or rest state, and the arm 136 resumes its original, centered position. Reverse drive may be applied by reversing the current direction to overcome contact sticking.

The voltage source may direct current through the suspension 124 in a direction 196 opposite to the direction 192. By cross-product of the current vector with the magnetic vector, a Lorentz force is produced as represented by the force vector 198. This force induces deflection of the suspension portion 134 and suspension beams 150 and towards the right. The arm 136 carried by the suspensions 124, 150 and 156 also translates rightward, thereby moving the contact bridge 172 into electrical contact with the terminals 166 and 168, thereby closing the switch 163. Additionally, movable capacitor plate 144 is moved towards the fixed plate 148, thus providing electrostatic hold.

By alternating the direction of the current through the suspension 124, the arm 136 may be translated left or right. Such lateral movement to either side enables closure of switches either to the left or right, enabling the construction of a double-throw switch with MEMS technology. The incorporation of a switch on each side of the center suspension 124 (with suspension beams 150 and 156 as added anchored support) provides for greater balance than for a single-pole single-throw (SPST) switch.

The embodiment of FIG. 2 comprises a three-suspension structure, including the suspension 124 and the two arm-supporting suspension beams 150 and 156. It will be apparent that as an alternative, the device of FIG. 2 may incorporate more than three suspensions or simply a single armature suspension or two suspensions. Further, where multiple suspensions are utilized, any one or more of the suspensions may be electrically active to carry Lorentz force-generating electrical current. Still further, it will be evident that the device need not be structured symmetrically about a central suspension, as is the case of the embodiment of FIG. 2; because of the minute sizes and masses of the components of an actuator of the invention, gravity and inertia are not significant factors. Further yet, it will be apparent that the two electrostatic hold capacitors (comprising the plate pairs 142/146 and 144/148) may be integrated or combined into a single capacitor structure comprising a movable plate disposed between a pair of fixed plates.

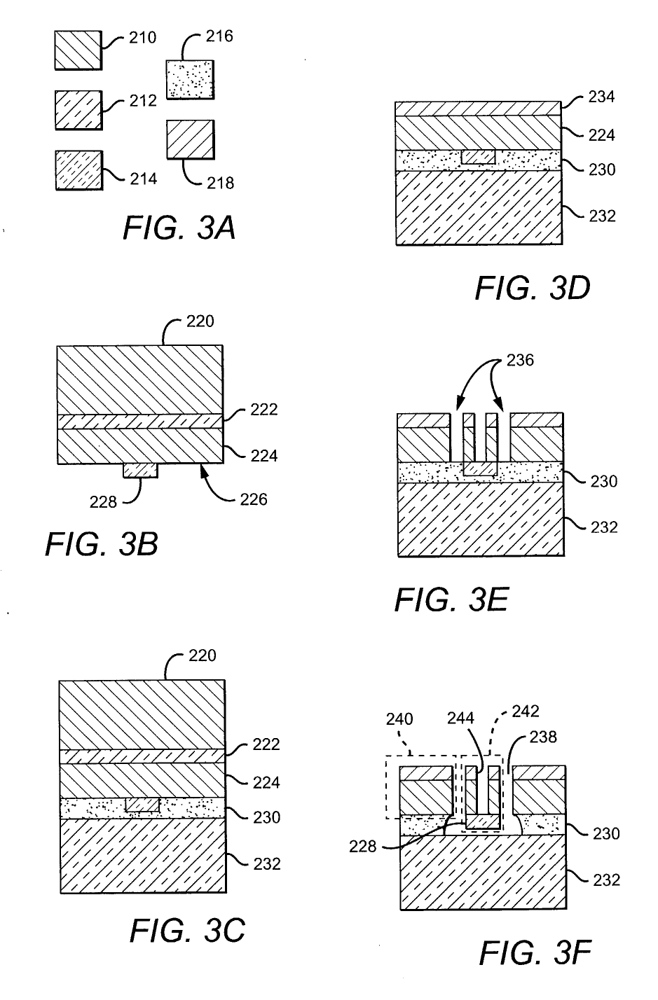

FIGS. 3B-3F show, in cross section, the steps for fabricating the portion of the switch 120 seen along the section line 3-3 in FIG. 2. FIG. 3A shows cross-hatchings identifying the various materials for the layers to be deposited. In FIG. 3A, the reference numeral 210 represents silicon (Si); 212 represents a substrate such as glass or silicon; 214 represents an insulator such as silicon dioxide (SiO₂) soda glass or silicon nitride (Si₃N₄); 216 represents an organic adhesive such as an epoxy; and 218 represents a conductive material such as a metal (e.g., Au, Cu or Al).

In FIG. 3B, a handle wafer 220 composed of silicon serves as a sacrificial platform for a sacrificial substrate 222 composed of glass or silicon. The thickness of the handle wafer 220 may be 0.5 mm (500 μm). A device layer 224 composed of silicon about 20 to 80 μm thick is deposited over the substrate 222. Disposed on a selected portion of an exposed surface 226 of the device layer 224 is a dielectric insulator 228 having a thickness of about 0.5 to 3 μm and composed of a silicon-based glass. Layer deposition is performed by methods well known in the art.

As shown in FIG. 3C, an adhesive layer 230 is deposited to cover the insulator 228 and the remaining portion of surface 226. The adhesive layer may have a thickness of between about 10 and 30 μm. Covering the adhesive layer 230 is a substrate wafer 232 having a thickness of about 0.5 mm (500 μm) and composed of silicon, glass, or other suitable material.

In FIG. 3D, the handle wafer 220 and substrate 222 have been removed and replaced by a metal conductor layer 234 for covering the device layer 224 (opposite the surface 226). The thickness of the metal layer 234 may be about 0.5 to 3 μm. Using a micromachining technique (e.g., dry etch, RIE), cavities or channels 236 are carved, as shown in FIG. 3E, from the metal layer 234 and the device layer 224. Portions of the epoxy layer 230 may be selectively removed (e.g., by wet etch) for deepening the cavity or channel 238 to the substrate wafer 232, thereby releasing the insulator 228 from the epoxy layer 230.

By such fabrication, an anchored element 240 (FIG. 3F) is secured to the substrate wafer 232, while a suspended element 242 is unconstrained to move above the substrate wafer 232. To reduce electrical conductivity, the suspended device 242 may be subdivided into segments connected by the insulator 228 by removing the silicon layer between the segments forming an insulation supported gap 244. Other manufacturing processes may be employed for alternative semiconductor materials such as gallium arsenide (GaAs) or indium phosphide (InP).

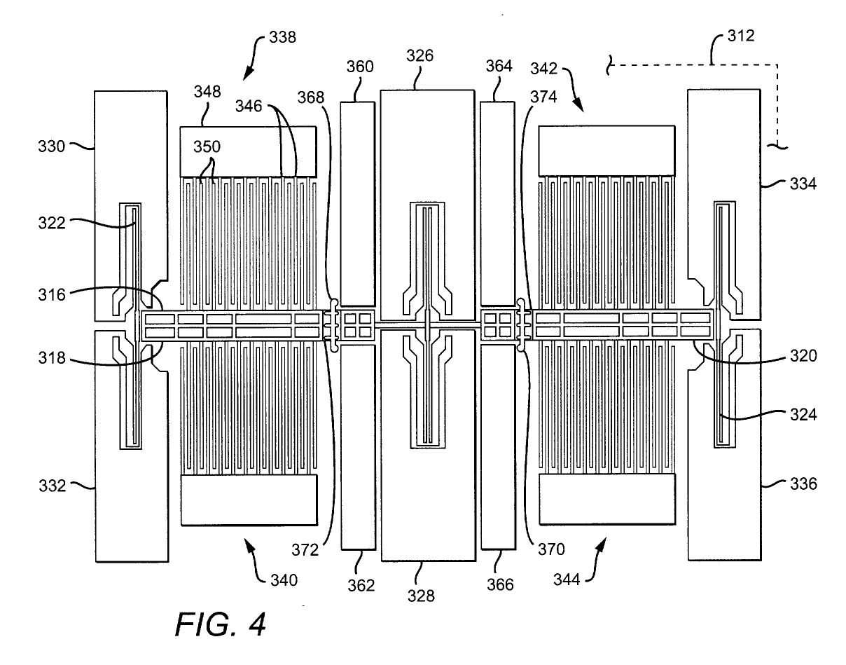

FIG. 4 shows yet another specific, exemplary embodiment of the invention comprising a MEMS 310 incorporating a Lorentz force actuator for operating a double-throw switch. The embodiment of FIG. 4 is fabricated on a substrate 312 by bulk micromachining, for example. The MEMS 310 comprises a centrally located, electrically conductive, flexible actuator element or armature in the form of a suspension 314 carrying an arm 316 having ends 318 and 320 coupled to flexible arm-supporting suspension beams 322 and 324, respectively. The center suspension 314, the end suspensions 322 and 324 and the arm 316 are suspended over the substrate 312 and are movable laterally in unison relative thereto.

A pair of center blocks 326 and 328 anchor the ends of the suspension 314 to the substrate. Hence, the center portion of the suspension is free to deflect laterally (left or right). The left suspension 322 is suspended between fixed blocks 330 and 332, while the right suspension is similarly suspended between fixed blocks 334 and 336.

As explained in connection with FIGS. 1 and 2, the passing of an electric current through the suspension 314 in the presence of a magnetic field oriented perpendicular to the plane of the drawing figure induces a Lorentz force causing the center portions of the suspensions 314, 322 and 324 to bend, thereby laterally translating the arm 316. As already explained, the arm 316 may be displaced either to the left or to the right, depending on the relative directions of the magnetic field and the current flow vectors.

A pair of comb capacitors 338 and 340 straddle the arm 316 adjacent to the left end suspension 322. Similarly, a pair of comb capacitors 342 and 344 straddle the arm 316 adjacent to the right end suspension 324. Since the comb capacitors 338, 340, 342 and 344 are identical, only the left comb capacitor 338 will be described. The comb capacitor 338 comprises a plurality of fixed capacitor plates 346 cantilevered from a capacitor block 348 and interleaved with a plurality of movable capacitor plates 350 projecting from the arm 316. The combination of the interleaved fixed and movable capacitor plates 346 and 350, appropriately powered electrically as already described, forms an electrostatic device or drive.

Disposed along the opposite sides of the center blocks 320 and 324 are pairs of spaced apart terminals 360, 362 and 364, 366, each pair being connected to an external load or signal conducting circuit (for simplicity, not shown in FIG. 4 but similar to the load circuit 68 in FIG. 1). The terminals 360, 362, 364 and 366 are fixed elements formed on the substrate 312. A first contact bridge 368 carried by the arm 316 is adapted to electrically couple the terminals 360 and 362 while a second contact bridge 370 carried by the arm 316 is adapted to electrically couple the terminals 364 and 366. The contact bridges 368 and 370 are mechanically coupled to but electrically isolated from the arm 316 by means of dielectric inserts 372 and 374, respectively. The left contact bridge 368 provides a switchable electrical connection between the associated terminals when the suspension 314 is deflected towards the right by the Lorentz force. Conversely, the right contact bridge 370 provides switchable electrical connection between the associated terminals when the suspension 314 is deflected towards the left by the Lorentz force.

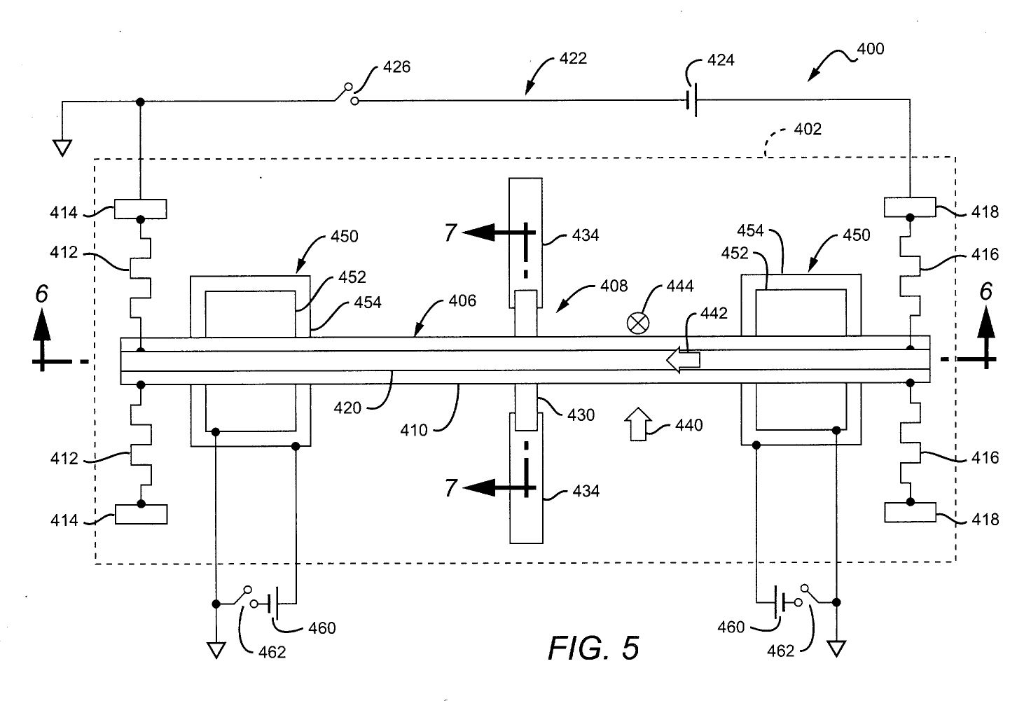

With reference to FIGS. 5-7, there is shown an apparatus including a MEMS 400 in accordance with a fourth specific, exemplary embodiment of the invention. The MEMS 400 may be fabricated using known surface micromachining techniques comprising the deposition on a substrate 402 of successive layers of desired materials and removing selected regions of certain of the layers to form the various MEMS elements. Among the layers formed on the substrate may be an epoxy layer 404 covering the upper surface of the substrate.

The MEMS 400 includes a longitudinally extending, deflectable Lorentz force actuator element 406 for operating a utilization device which in the specific example shown comprises a single-pole, single-throw electrical switch 408. The deflectable actuator element 406 comprises a suspension including a beam 410 supported at its ends by an anchor structure comprising at one end a pair of compliant, electrically conductive couplings 412 (such as folded beams having substantial effective support lengths) attached to the substrate by means of conductive posts or anchors 414 and, similarly, at the other end by a pair of compliant couplings 416 attached to anchors 418.

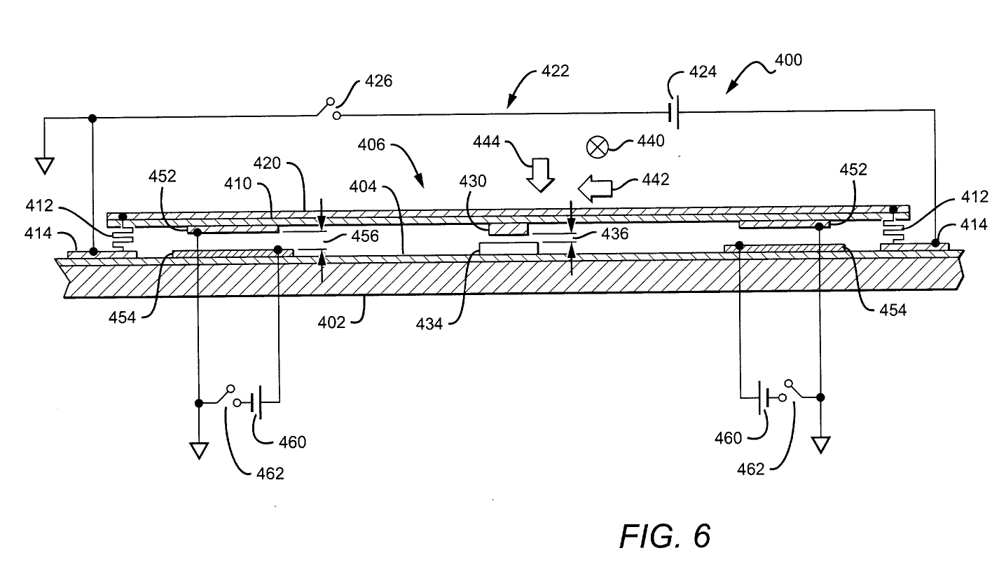

As seen in FIG. 6, the suspension 406 is deflectable or displaceable vertically relative to the substrate. The beam 410 may be made of an appropriate insulative material such as silicon dioxide and is preferably relatively stiff compared to the end couplings 412 and 416 so that during operation of the actuator bending of the beam 410 is limited. It will be apparent, however, that the beam 410 may be flexible or elastic and can even be more compliant than the end couplings in which case deflection is achieved principally through the bending of the mid-span of the beam.

Disposed on an upper, preferably planar surface of the beam 410 and integral therewith is an elongated electrical conductor 420 extending substantially the entire length of the beam. The ends of the conductor are connected through the couplings 412 and 416 and the anchors 414 and 418 at the opposite ends of the suspension to an actuator control circuit 422 comprising the series combination of an electrical power supply 424 and a switch 426 connected across the anchors.

Attached to the lower surface of the beam 410 at its center and extending perpendicular thereto is an electrically conductive bridge 430 having spaced apart contact surfaces 432. The bridge is movable vertically with the deflectable suspension so that the contact surfaces 432 make and break contact with a pair of spaced apart load circuit or signal line terminals 434. The bridge 430 and the terminals 434 comprise the elements of the switch 408. In the normally open state of the switch 408, a gap 436 separates the contact surfaces 432 from the terminals 434.

Operatively associated with the substrate and positioned adjacent thereto is a source of a magnetic field having lines of magnetic force which, in the specific example under consideration, extend in the direction of the arrow 440 in FIG. 5.

It will be seen that when electrical current passes through the conductor 420 in the direction of the arrow 442, the interaction of the current and the magnetic field produces a Lorentz force acting in the direction of the arrow 444, deflecting or displacing the suspension 406 toward the substrate thereby causing the contact surfaces of the bridge 430 to make contact with the terminals 434 to close the switch 408.

Adjacent each end of the suspension 406 is an electrostatic hold device comprising a parallel plate capacitor 450. Each capacitor comprises a movable electrode or plate 452 carried by the actuator element 406 and overlying a fixed electrode or plate 454 formed on the epoxy layer 404 on the upper surface of the substrate. The capacitor plates are separated by a gap 456 that in the open state of the switch 408 is larger than the gap 436 separating the bridge contact surfaces 432 and the terminals 434. Connected across each parallel plate capacitor 450 is an external electrical drive or charging circuit including a power supply 460 and, optionally, a switch 462. In the absence of the switch 462, the electrostatic devices will be continuously powered. As already noted, an electrostatic hold device in the form of a comb capacitor may be utilized in place of each parallel plate capacitor 450.

When the actuator element or suspension 406 is deflected toward the substrate under the action of the Lorentz force, the gap 456 of each of the capacitors 450 is eventually reduced to within the snap-down range causing the movable capacitor plate 452 to approach the corresponding fixed plate 454 and the contact surfaces of the bridge 430 to make contact with the terminals 434 so as to close the signal or load circuit. The control circuit switch 426 may be opened terminating the higher power consumption Lorentz force; the bridge 430 will remain in contact with the spaced apart terminals 434, however, under the action of the electrostatic devices whose power consumption is very low. Where the charging circuits for powering the electrostatic devices 450 include switches 462, opening thereof will typically cause the load circuit switch 406 to open. Contact sticking may be overcome by reversing the Lorentz force direction by either reversing the direction of the current through the conductor or the direction of the magnetic field. Where electrostatic device switches are not included, the load circuit switch 408 is opened by reversing the Lorentz force direction.

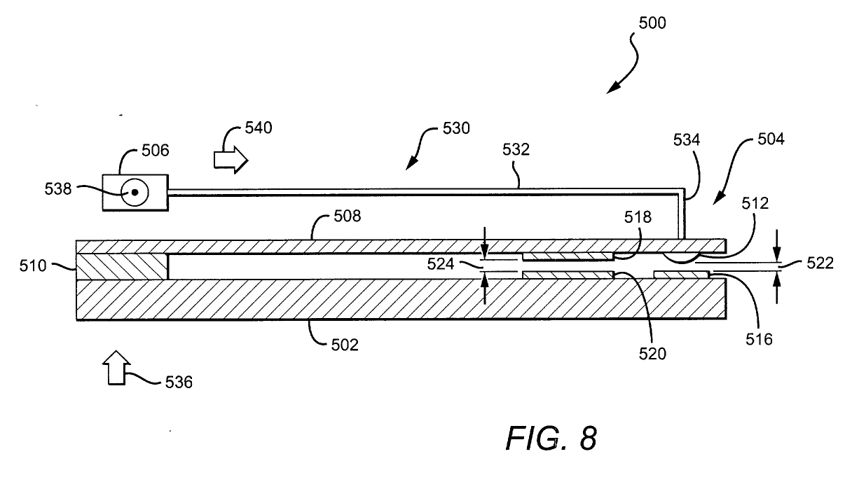

FIG. 8 shows a MEMS 500 in accordance with a fifth specific, exemplary embodiment of the invention. As before, the MEMS may be fabricated using known surface micromachining techniques comprising the deposition on a substrate 502 of successive layers of desired materials and removing selected regions of certain of the layers to form the various MEMS elements.

The MEMS 500 includes a deflectable Lorentz force actuator element for operating a utilization device which in the specific example shown in FIG. 8 comprises a single-pole, single-throw electrical switch 504. The deflectable Lorentz force actuator may comprise an elongated, electrically conductive suspension 506 of any of the types already described. In FIG. 8, suspension 506 extends in a direction perpendicular to the plane of the drawing for conducting current bidirectionally. The MEMS 500 includes a thin, compliant cantilever 508 fixed at one end to the substrate by means of an anchor 510 and including adjacent the opposed, free end 512 a movable electrical contact 514 in confronting relationship with a fixed electrical contact 516 formed on the substrate 502. The free end 512 of the cantilever also carries a plate 518 forming the movable electrode of an electrostatic hold device of the parallel plate capacitor type. The electrostatic hold device includes a fixed plate 520 carried by the substrate opposite the movable plate 518.

In the open state of the MEMS 500, which state is shown in FIG. 8, a gap 522 separates the switch contacts 514 and 516 which, for the reasons already described, may be somewhat smaller than the gap 524 separating the capacitor plates 518 and 520. By way of example and not limitation, the gap 522, in the open state of the MEMS switch, may be of the order of one micron in which case, again by way of example, the movable contact 514 may be located along the cantilever 508 about 100 microns from the anchor 510.

The actuator element or suspension 506 is connected to the cantilever 508 by means of a mechanical coupling 530 comprising a first portion 532 having an end attached to the suspension 506 and a second portion 534 attached to the cantilever, for example, at a point over the movable contact 514. In the specific embodiment of FIG. 8, the suspension 506 is shown positioned over the cantilever anchor 510 but it will be evident that the position of the suspension as well as the position of the connection point between the mechanical coupling 530 and the cantilever 508 may be varied as needed depending upon the excursion of the suspension and other variables which will be apparent to those skilled in the art.

Positioned adjacent to the substrate 502 is a source of a magnetic field having lines of magnetic force which, in the specific example under consideration, extend in the direction of the arrow 536.

It will be seen that when electrical current passes through the electrically conductive suspension 506 in the direction of the arrow 538, the interaction of the current and the magnetic field produces a Lorentz force acting in the direction of the arrow 540, deflecting or displacing the suspension 506 toward the right in FIG. 8 thereby causing the contact 514 move in a generally arcuate or rotational path about the anchor 510 and into engagement with the fixed contact 516 to close the MEMS switch. As before, connected across the capacitor plates 518 and 520 is an external drive or charging circuit (not shown) along the lines already described. Again, an electrostatic hold device in the form of a comb capacitor may be utilized in place of the parallel plate capacitor. The operation of the electrostatic drive in the embodiment of FIG. 8 is the same as that already described. Thus, deenergization of an actuator control circuit (not shown in FIG. 8) terminates current flow through the suspension 506. The switch contacts 514 and 516, however, will remain closed under the action of the electrostatic drive whose power consumption is very low. As before, contact sticking may be overcome by reversing the Lorentz force direction by either reversing the direction of the current through the suspension 506 or the direction of the magnetic field. Where the electrostatic drive is continuously energized, the MEMS switch is opened by reversing the Lorentz force direction.

Devices that have been constructed in accordance with aspects of the present invention have been tested and have shown the following characteristics:

Within a magnetic field having a magnetic field strength of 0.5 T, an electric current ranging from 1 to 150 mA may provide a Lorentz force ranging between 0.9 μN to 67.5 μN. Electrostatic contact and hold force supplied by a parallel plate capacitor drive may yield 3 μN from 1 V, although voltages as high as 20 V may be used. Electrostatic force rises nonlinearly with voltage, e.g., 10 V corresponds to 300 μN. While the Lorentz actuation may require higher current than an equivalent electrostatic actuation, the applicable duration may be much shorter.

A substantial electrical power supply may be required to produce the Lorentz effect, but only for a short duration sufficient to deflect the suspension(s) and close the capacitor drive circuits. A compliant MEMS structure may have a comparatively low resonance frequency, e.g., f₀=750 Hz that yields a power of 16 nJ/cycle to produce a force of 0.9 μN. Such a hybrid actuator may require 0.9 mA to actuate by the Lorentz force and 0.9 V to maintain by electrostatic attraction. By contrast, a stiff MEMS structure may possess a comparatively high harmonic frequency, e.g., f₀=7.9 kHz that yields 0.43 μJ/cycle to produce 9 μN of force, requiring 20 mA to actuate and 6 V to hold. A conventional electrostatic switch requires power consumption of 0.16 nJ/cycle, with an applied voltage of 80 V for supplying a force of 50 μN.

The MEMS actuator of the present invention exhibits more rapid response than a conventional thermal MEMS actuator. For example, tests have shown a contact closing (switch-on) time of 0.17 ms and an opening (switch-off) time of 0.08 ms for an suspension length of 0.8 mm. The invention has the potential to further reduce these actuation times. In contrast, a thermal MEMS switch of similar size may require about 10 ms for closing and opening.

As noted, through use of the Lorentz force whose direction can be reversed by simply reversing the direction of electrical current through the suspension, the MEMS actuator of the present invention has the advantage of making available a repulsive force to actively open a stuck closed switch. The Lorentz effect may be used for attractive or repulsive action for a switch, enabling active disengagement and/or double-throw switch configurations, in contrast to an electrostatic switch. A current source of 75 mA may force open a switch held shut by 4 V for a hold force of 48 μN. By comparison, the frictional and surface tension forces on a pair of square gold contacts about 1 μm on each side may yield ˜40 μN and hence represent significant resistance.

While several illustrative embodiments of the invention have been shown and described, numerous variations and alternative embodiments will occur to those skilled in the art. All such variations and alternative embodiments are contemplated, and can be made without departing from the spirit and scope of the invention as defined in the appended claims.

For example, although the MEMS switches specifically described and shown herein provide for metal-to-metal electrical contact between the switch contact elements, it will be evident to those skilled in the art that the teachings of the invention apply equally to capacitive micromechanical switches. Such switches are particularly useful in telecommunications applications, for example, for switching RF circuits. A capacitive micromechanical switch typically comprises a pair of parallel capacitor plates, one being fixed, for example, on the substrate, the other being suspended and movable (by action of the Lorentz force actuator disclosed herein) relative to the fixed plate so that the gap between them can be varied so as to vary the capacitance and hence change the state of the switch. Although such capacitive switches are technically non-contact RF switches, for purposes of the present invention they are interchangeable with metal-to-metal contact switches and are accordingly intended to fall within the scope of the appended claims.

What is claimed is:

1. A microelectromechanical system (MEMS) formed on a substrate, the MEMS comprising:
a utilization device having a first state and a second state;
a Lorentz force actuator comprising an actuator element coupled to the utilization device, the actuator element being displaceable by the Lorentz force to alter the state of the utilization device from the first state to the second state thereof; and
an electrostatic device coupled to the utilization device, the electrostatic device being electrically chargeable to electrostatically hold the utilization device in the second state thereof.

2. The MEMS of claim 1 in which:
the utilization device comprises a device selected from the group consisting of an electrical utilization device, a fluidic utilization device, an optical utilization device and a mechanical utilization device.

3. The MEMS of claim 1 in which:
the utilization device comprises an electrical switch, the first state comprising an open state of the switch and the second state comprising a closed state of the switch.

4. The MEMS of claim 1 in which:
the actuator element of the Lorentz force actuator comprises a suspension.

5. The MEMS of claim 4 in which:
the suspension comprises a beam.

6. The MEMS of claim 5 in which:
the beam comprises opposite ends anchored to the substrate and a deflectable portion between the opposite ends, the deflectable portion of the beam being coupled to the utilization device.

7. The MEMS of claim 4 in which:
the deflectable portion of the suspension is deflectable laterally relative to the substrate.

8. The MEMS of claim 4 in which:
the deflectable portion of the suspension is deflectable vertically relative to the substrate.

9. The MEMS of claim 8 in which:
the electrostatic device comprises a parallel plate capacitor adjacent each of the ends of the suspension, each of the parallel plate capacitors comprising a movable plate attached to the suspension and a fixed plate carried by the substrate.

10. The MEMS of claim 4 in which:
the suspension comprises opposite ends, each of said ends being attached to the substrate by a compliant coupling.

11. The MEMS of claim 10 in which:
the suspension includes a beam stiffer than said compliant couplings.

12. The MEMS of claim 1 in which:
the electrostatic device comprises a parallel plate capacitor.

13. The MEMS of claim 12 in which:
the parallel plate capacitor comprises a fixed plate attached to the substrate and a movable plate coupled to the utilization device.

14. The MEMS of claim 1 in which:
the electrostatic device comprises a comb capacitor.

15. The MEMS of claim 14 in which:
the comb capacitor comprises a plurality of fixed plates interleaved with a plurality of movable plates, the plurality of fixed plates being attached to the substrate and the plurality of movable plates being coupled to the utilization device.

16. The MEMS of claim 1 in which:
the actuator element is displaceable bidirectionally in response to the action of the Lorentz force.

17. The MEMS of claim 16 in which:
the utilization device has a third state; and
the actuator element is displaceable by the Lorentz force in one direction to alter the state of the utilization device from the first state to the second state and in another direction, opposite the one direction, to alter the state of the utilization device from the first state to the third state.

18. The MEMS of claim 17 in which:
the utilization device comprises a double-throw electrical switch.

19. The MEMS of claim 1 in which:
the actuator element comprises a plurality of parallel suspensions, each of the plurality of suspensions comprising opposite ends anchored to the substrate and a deflectable portion between the opposite ends coupled to the utilization device, at least one of the suspensions being electrically conductive.

20. The MEMS of claim 1 in which:
the utilization device comprises an electrical switch, the first state comprising an open state of the switch and the second state comprising a closed state of the switch, the electrical switch including a fixed switch contact carried by the substrate and a movable switch contact mounted adjacent the free end of a cantilever having a fixed end secured to the substrate, the actuator element being coupled to the cantilever.

21. An apparatus comprising:
a MEMS module comprising:
an armature deflectable between a first state and a second state;
a utilization device responsive to the deflection of the armature and movable thereby from a first position corresponding to the first state of the armature, to a second position corresponding to the second state of the armature; and
an electrostatic device coupled to the utilization device;
a first voltage source connectable to the armature for passing an electrical current through the armature;
a second voltage source connectable to the electrostatic device; and
means for producing a magnetic field oriented to intercept the electrical current passing through the armature, the passage of current through the armature causing the armature to deflect from the first state to the second state thereof in response to the action of the Lorentz force, the electrostatic device being electrically chargeable by the second voltage source to electrostatically hold the utilization device in the second position thereof.

22. The apparatus of claim 21 in which:
the first voltage source is connectable to the armature for passing an electrical current through the armature bidirectionally, the passage of current in one direction through the armature causing the armature to deflect from the first state toward the second state in response to the Lorentz force acting in a first direction, and the passage of current in the other direction through the armature causing the armature to deflect from the second state toward the first state in response to the Lorentz force acting in a second direction.

23. The apparatus of claim 21 in which:
the electrostatic device comprises a capacitor including at least one movable plate coupled to the armature and at least one plate fixed relative to the movable plate, the second voltage source being connected across the capacitor.

24. The apparatus of claim 21 in which:
the armature comprises a flexible suspension having fixed ends and a deflectable portion between the fixed ends, the deflectable portion being coupled to the utilization device.

25. A MEMS switch formed on a substrate, the MEMS switch comprising:
an electrically conductive actuator element attached to an electrically conductive anchor structure formed on the substrate, at least a portion of the actuator element being movable relative to the substrate between a rest state and a forced state, the actuator element being adapted to be connected to an electrical power supply through the anchor structure for passing an electrical current through the actuator element, the movable portion of the actuator element carrying an electrical contact means; and
a load circuit terminal means formed on the substrate, the electrical contact means carried by the movable portion of the actuator element confronting said load circuit terminal means and being separated therefrom by a gap in the rest state of the movable portion of the actuator element, and wherein passing an electrical current through the actuator element in the presence of a magnetic field intercepting the electrical current causes the movable portion of the actuator element to move from the rest state to the forced state in response to the action of the Lorentz force to close the gap between the electrical contact means and the load circuit terminal means and to thereby close the MEMS switch.

26. The MEMS switch of claim 25 in which:
the movable portion of the actuator element is coupled to an electrostatic drive chargeable to electrostatically hold the movable portion of the actuator element in the forced state.

27. The MEMS switch of claim 26 in which:
the electrostatic drive comprises a parallel plate capacitor.

28. The MEMS switch of claim 27 in which:
the parallel plate capacitor comprises a pair of plates separated by a gap, the gap separating the plates being larger than the gap separating the electrical contact means from the load circuit terminal means.

29. The MEMS switch of claim 26 in which:
the electrostatic drive comprises a comb capacitor.

30. The MEMS switch of claim 29 in which:
the comb capacitor comprises a plurality of first electrodes interleaved with a plurality of second electrodes, adjacent first and second electrodes being separated by a gap, the gap separating said adjacent first and second electrodes being larger than the gap separating the electrical contact means from the load circuit terminal means.

31. The MEMS switch of claim 25 in which:
the actuator element comprises a flexible beam having opposite ends, the anchor structure comprises an anchor adjacent each of the ends of the beam, the beam being fixed at each of the ends to the corresponding anchor, the beam being suspended over the substrate and including a central portion comprising the movable portion of the actuator element.

32. The MEMS switch of claim 31 in which:
the movable portion of the actuator element is disposed to move laterally relative to the substrate.

33. The MEMS switch of claim 25 in which:
the actuator element comprises a beam having opposite ends, the anchor structure comprises an anchor adjacent each of the ends of the beam, the beam being attached at each of the ends to a corresponding anchor by a compliant suspension, the beam being suspended over the substrate.

34. The MEMS switch of claim 33 in which:
the beam is movable vertically relative to the substrate.

35. The MEMS switch of claim 25 in which:
the load circuit terminal means comprises a pair of spaced apart terminals formed on the substrate; and
the electrical contact means comprises an electrically conductive bridge having spaced apart contact surfaces disposed to engage the pair of spaced apart terminals when the movable portion of the actuator element is moved to the forced state.

36. The MEMS switch of claim 35 in which:
the electrically conductive bridge is carried by a cantilevered arm suspended over the substrate and having an end attached to the movable portion of the actuator element and a free end.

37. The MEMS switch of claim 36 in which:
the electrically conductive bridge is electrically isolated from the cantilevered arm.

38. The MEMS switch of claim 25 in which:
the load circuit terminal means comprises (i) a first load circuit terminal means comprising a first pair of spaced apart terminals and (ii) a second load circuit terminal means comprising a second pair of spaced apart terminal means;
the movable portion of the actuator element being movable between the rest state and a first forced state in response to an electrical current passing through said actuator element in one direction and between the rest state and a second forced state in response to an electrical current passing through said actuator element in an opposite direction; and
the electrical contact means comprises (i) a first electrically conductive bridge having spaced apart contact surfaces disposed to engage the first pair of spaced apart terminals in the first forced state of the movable portion of the actuator element, and (ii) a second electrically conductive bridge having spaced apart contact surfaces disposed to engage the second pair of spaced apart terminals in the second forced state of the movable portion of the actuator element.

39. The MEMS switch of claim 38 in which:
the movable portion of the actuator element is coupled to an electrostatic drive chargeable to electrostatically hold the movable portion of the actuator element in the first or the second forced state.

40. The MEMS switch of claim 38 in which:
the movable portion of the actuator element is coupled to (i) a first electrostatic drive energizable to electrostatically hold the movable portion of the actuator element in the first forced state, and (ii) a second electrostatic drive engergizable to electrostatically hold the movable portion of the actuator element in the second forced state.

41. The MEMS switch of claim 40 in which:
the first and second electrostatic drives comprise parallel plate capacitors.

42. The MEMS switch of claim 40 in which:
the first and second electrostatic drives comprise comb capacitors.

43. The MEMS switch of claim 38 in which:
the first and second electrically conductive bridges are carried by an arm suspended over the substrate and attached to the movable portion of the actuator element.

44. The MEMS switch of claim 43 in which:
the first and second bridges are electrically isolated from the arm.

45. The MEMS switch of claim 43 in which:
a first portion of the arm is supported by a first flexible beam having opposite ends anchored on the substrate and a second portion of the arm is supported by a second flexible beam having opposite ends anchored on the substrate.

46. A method for operating a MEMS actuator, the MEMS actuator comprising an electrically conductive actuator element movable between a first position and a second position, the method comprising the steps of:
passing an electrical current through the actuator element in a predetermined direction in the presence of an intercepting magnetic field to move the actuator element from the first position toward the second position in response to the action of the Lorentz force;
electrostatically holding the actuator element in the second position; and
terminating the electrical current through the actuator element.

47. The method of claim 46 further comprising the step of:
passing an electrical current through the actuator element in a direction opposite said predetermined direction to move the actuator element from the second position toward the first position in response to the action of the Lorentz force.

48. The method of claim 46 further comprising the steps of:
terminating the electrostatic hold of the actuator element; and
passing an electrical current through the actuator element in a direction opposite said predetermined direction to move the actuator element from the second position toward the first position in response to the action of the Lorentz force.

49. The method of claim 46 in which the actuator element is further movable between said first position and a third position opposite said second position, the method further comprising the step of:
passing an electrical current through the actuator element in a direction opposite said predetermined direction to move the actuator element from the first position toward the third position in response to the action of the Lorentz force.
